(19) United States
(12) Patent Application Publication
(10) Pub. No.: US 2018/0332836 A1
(43) Pub. Date: Nov. 22, 2018

(54) JV's Spring Connect

(71) Applicant: John Vogel, Gibsonton, FL (US)

(72) Inventor: John Vogel, Gibsonton, FL (US)

(21) Appl. No.: 15/597,572

(22) Filed: May 17, 2017

(51) Int. Cl. A01K 91/04

(52) U.S. Cl. CPC A01K 91/04

(57) ABSTRACT

The apparatus connects and secures fishing plugs under heavy pressure. It is comprised of a spring, tapered hook and shaft and sliding sleeve. JV's Spring Connect keeps fishing plugs in place by leveling tension. The force of the spring on sleeve that slides over the tapered hook and shaft locks the connector into a closed and secured position. The apparatus is scalable up or down and can be attached to any type of plug.

### BACKGROUND OF THE INVENTION

This invention relates to fishing lures, specifically to connecting lures to fishing apparatuses through a quick release spring connector.

When trolling for Mackerel, Kingfish, Grouper, Tuna etc. it is typical to use snap swivels, which connect to the fishing hooks to hold the plug in place. However, when a fish is hooked the snap swivels bend under heavy pressure. They are also bulky and lures are often lost. When the lure is lost, the fish is also lost.

Another disadvantage of current lure connecting systems is the large size in relation to the lure. Because they are bulky, fish under water readily see them.

### SUMMARY OF THE INVENTION

Therefore, the primary objective of the invention is to provide a lure connector that is strong enough to withstand the pressure applied to the connector by hooked fish.

A second objective is to provide a simple system for attaching and changing lures.

A third objective is to provide a connector that is streamlined with the lure to be more invisible to fish.

A feature of the invention is a spring-loaded mechanism that holds the sleeve on the connector shaft when extended to keep the lure secure, even with resistance. To change lures, push the sleeve down, slide the lure ring off the tapered hook and put on a new one.

The sleeve covers ¼ of the hook connector, which locks the lure in place. The spring keeps the tension on the sleeve so the lure ring cannot come loose or off. The stainless steel shaft on the connector is stronger than the wire on standard snap swivels, which prevents it from bending.

The narrow design also provides strength, so that the connect will not bend when a fish is hooked and pulling. The stainless steel barrel reinforces the strength of the design.

The invention is scalable in size up or down and could have applications outside of fishing.

A patent search determined that the following patents are related to this invention:

U.S. Pat. Nos. 724,362, 835,766, 1,156,152, 1,713,041, 1,779,343, 1,867,555, 2,784,519, 2,796,695, 2,826,855, 2,875,495, 3,350,753, 3,388,496, 5,113,616, 5,138,790, 5,605,004, 5,680,726, 8,020,339, 2003018284, 2007011909 and 2012003676.

### BRIEF DESCRIPTION OF THE DRAWINGS

FIG. 1 shows the spring connect in the closed or locked position. This is how the apparatus goes into the water when a lure is attached, which is also the natural or resting position of the apparatus.

(12A) is the spring in the uncompressed position or resting position. The spring acts as part of the locking device with the barrel (24) and the tapered hook (32). The spring applies force on the barrel such that it prevents the barrel from sliding and allowing the apparatus to open.

(24) is a stainless steel barrel that is ⅓ of the length of the shaft (28). It is flattened on the sides to make the connector streamlined and less visible to fish. The barrel slides along the length of the shaft to open and close the connector.

(28) is the shaft of the connector. It extends from the loop (42) to the crook of the hook (30). The spring (12) fits over the shaft (28) closest to the loop (42). The barrel (24) stacks onto the shaft behind the spring (12).

(30) is the crook of the hook. The length of this section determines the width of the upper portion of the hook (32).

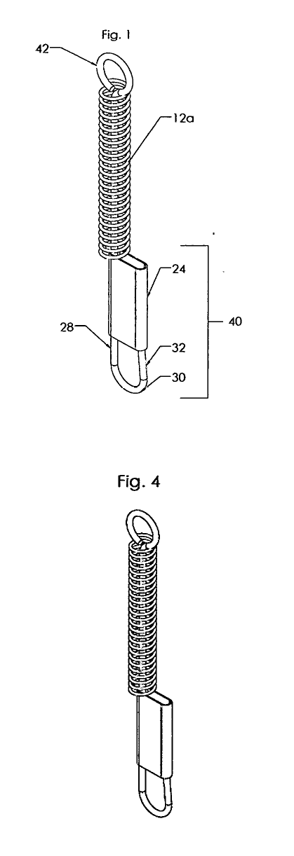

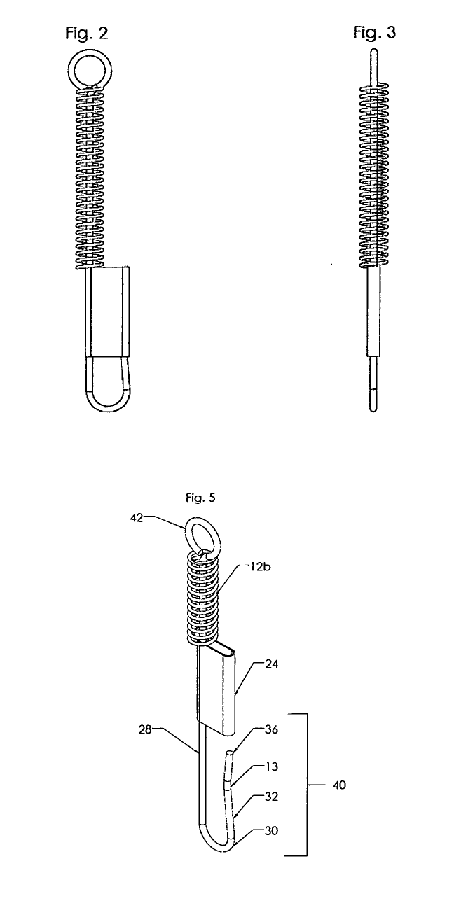

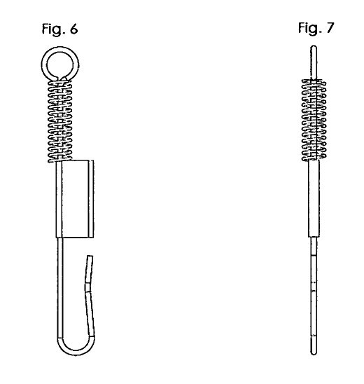

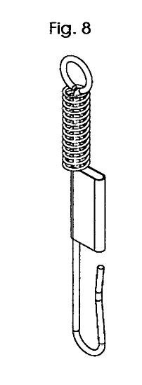

(32) is the upper portion of the hook. It is the widest section of the hook and acts as a stopper for the barrel (24) when the spring (12) is uncompressed in the locked position (FIG. 1)

(42) is the loop that attaches the Spring Connect to the fishing line. It also acts as a stop for the spring in both compressed and uncompressed positions.

FIG. 2 is a side view the spring connect in the locked position such that the spring is uncompressed and the barrel is over the tapered hook and static.

FIG. 3 is a posterior view of the Spring Connect in the locked position. This view exhibits the streamlined design.

FIG. 4 is an isometric view of the Spring Connect in the locked position.

FIG. 5 shows the apparatus in the open position. This is the position of the Spring Connect in which to load or change lures.

(12B) is the spring in the compressed position. This position is accomplished by pushing the barrel (24) against the spring. This action opens the connector to release and load lures. The spring only stays compressed while the fisherperson is holding the barrel against the spring, applying force.

(36) is the lower portion of the tapered hook. The barrel slides over this portion first to lock the Spring Connect in place. The slight bend away from the shaft makes the hook accessible and allows for easy changing of lures.

(13) is the most tapered portion of the hook relative to the shaft. The angle created by this bend ensures the barrel an effortless connection to the upper portion of the hook (32), which is the stop for the barrel, thus locking the Spring Connect. (13) tapers in from the upper portion of the hook (32). This tapering effect is a key piece in the patentability of my invention. The tapering allows the barrel (24) to slide over the hook, securing the lure. The barrel slides until it reaches the upper portion of the hook (32) The narrow design also provides strength, so that the connect will not bend when a fish is hooked and pulling.

(40) is the entirety of the hook portion on the Spring Connect. It is comprised of individual portions (30), (32), (13), and (36). It is understood that further references to the hook will include the four portions listed above.

FIG. 6 is a side view of the Spring Connect in the open or load/unload position. An external force must push the barrel against the spring to achieve this position. For example; A fisherperson holding the Spring Connect must use his/her fingers on either side of the barrel to slide the barrel against the spring and away from the hook.

FIG. 7 is a posterior view of the Spring Connect in the open or load/unload position.

FIG. 8 is an isometric view of the Spring Connect in the open or load/unload position.

### DETAILED DESCRIPTION OF THE PREFERRED EMBODIMENT

For the purposes of the invention description herein, the terms “top”, “bottom”, “right” and “left” will be of the orientation of FIG. 2 and FIG. 6 from the attached drawings. It is understood by the user that the Spring Connect comprised of a hook (30), (32), (13), (36), shaft (28), spring (12) and barrel (24) is scalable up or down depending on the size of lure used or size of desired catch.

It is preferable that the fishing hook is constructed with hardened stainless steel or a material equal in strength and quality. The top of the shank is bent to form a loop (42) for attaching Spring Connect to fishing line. The tapered hook is constructed by bending the bottom of the stainless steel shaft (28) into the crook (30) in such a way that forms the tapered upper portion of the hook (32), bend (13) and angled lower portion of the hook (36). The stainless steel spring (12) slides over the shaft (28) after the loop (42) is formed, but before the hook is bent. The stainless steel barrel (24) slides onto the shaft (28) after the spring, but before the hook is formed. The barrel configuration is flat on two sides and curved on two sides (24). The hook (40) and shaft (28) are directly adjacent to the curved sides of the barrel as shown in (FIG. 1). Compressing a standard stainless steel cylinder into the desired configuration forms the barrel.

A method for attaching lures to the Spring Connect involves an external force such as a bare hand sliding the barrel (24) up the shaft (28) towards the loop (42) thus compressing the spring (12B). While holding the barrel against the spring with one hand, use free hand to slide the loop from a fishing lure over the tip of the hook (36) until it is resting in the crook (30). When lure is in place, simply release the hold on the barrel. Barrel will automatically return to the locked position over the hook (40). The Spring Connect is now ready for use. The basic process is required to unload or change the lure.

Furthermore, stainless steel is the ideal choice for this invention since most deep-water running plugs have a silver lip to pull the lure into the water. The stainless steel matches the color of the lip, thus enticing fish to strike the lure. The Spring Connect can also be produced in a dark color such as blue or black to match the occasional dark lure.

Another advantage of this invention is the cost savings to the user. Since available lure attachment means are much weaker than the Spring Connect and prone to bending, users must replace connection systems often. The Spring Connect, if sized appropriately, will not bend or warp which saves the user money in replacement costs.

The specifications of this invention may vary according to user needs or specific requirements. This invention may be adapted to various sizes and hook types. It is understood that any and all adaptations of the invention may be implemented without departing from the spirit of the invention.

1. I claim a fishing lure connector comprising a spring-loaded sleeve and tapered hook that enables user a quick release system for loading and reloading fishing lures.

2. I claim a fishing lure connector comprising a sliding sleeve that covers the hook and shaft when locked into place by spring tension wherein the sleeve comes to a stop at a point dictated by the increased width of the hook due to the tapered design.

3. I claim a fishing lure connector comprising a hook that tapers inward to the shaft of the connector wherein the distance between the base of the hook and the medial portion of the shaft is half that of the distance between the origination point of the hook and shaft.

4. I claim a future improvement to the Spring Connect comprising a locking device that holds the barrel open in the compressed spring position to load and unload lures.

5. I claim a future improvement to the Spring Connect comprising a lip attached to the barrel to better grip and slide the barrel to the open position.

6. I claim a future improvement to the Spring Connect comprising a locking device that holds the barrel closed in the decompressed spring position to ensure the apparatus remains closed.
